(19) United States
(12) Patent Application Publication
(10) Pub. No.: US 2017/0263338 A1
(43) Pub. Date: Sep. 14, 2017

(54) Exothermic Transmutation Method

(71) Applicants: Ad Maiora LLC, Mission Viejo, CA (US); Gapmed Limited, Limassol (CY)

(72) Inventor: Giuseppe de Bellis, Ferrara (IT)

(21) Appl. No.: 15/504,672

(22) PCT Filed: Aug. 7, 2015
(86) PCT No.: PCT/EP2015/068281

§ 371 Date: Feb. 17, 2017

(30) Foreign Application Priority Data
Aug. 20, 2014 (CA) 2860128

(51) Int. Cl. G21B 3/00; G21G 1/10

(52) U.S. Cl. CPC G21B 3/008; G21G 1/10

(57) ABSTRACT

An exothermic transmutation method for at least partially deactivating radioactive material, the method comprising the steps of: —Arranging a dusty compound comprising at least a transition metal in a chamber (7) of a reactor (1) outside a closed container; —Arranging the radioactive material in said chamber (7), the radioactive material being and staying encapsulated in said closed container; —Providing hydrogen in contact with the dusty compound and with the radioactive material at a pressure higher than the ambient pressure; —Generating an electric field in the chamber (7), the electric field being applied to the dusty compound and the radioactive material; —Energizing the dusty compound by heating, then generating a transmutation of said at least one transition metal into another transition metal and proton emission towards the radioactive material, said radioactive material being at least partially deactivated, —Removing thermal energy from the reactor (1).

The present invention relates to the field of energy production by transmutation, more precisely by transmutation of radioactive isotopes. For meeting the need of safe energy, the carbon combustion has to be replaced by another source. The use of uranium fission as an energy source, derived from military searches in the 50's, has the drawback of generating a large quantity of radioactive waste while being exposed to safety hazards. The present invention also relates to the field of waste treatment to reduce the radioactivity and/or the toxicity.

In the past, some researches were concerned with deuterium received in a crystalline structure. Deuterium is expensive and reactions are difficult to forecast.

Other attempts have been made with the use of Li, Ni, Cu, Pd and Ti as nuclear fuel in a colloidal mixture irradiated by electromagnetic radiations. However a moderator was necessary.

Prof. Sergio Focardi published several documents on Ni—H heat production in the late 90′.

Attempts based on Ni⁶² in a copper tube with hydrogen have been made. The energy production was below expectation.

Attempts based on proton emission by a transition metal towards another material were made. However, the reactor was complex.

There is a need for a safe and reliable method adapted to industrial requirements.

An exothermic transmutation method for at least partially deactivating radioactive material, comprises the steps of:
Arranging a dusty compound comprising at least a transition metal in a chamber of a reactor outside a closed container;
Arranging the radioactive material in said chamber, the radioactive material being and staying encapsulated in said closed container;
Providing hydrogen in contact with the dusty compound and with the radioactive material at a pressure higher than the ambient pressure;
Generating an electric field in the chamber, the electric field being applied to the dusty compound and the radioactive material;
Energizing the dusty compound by ultrasonic waves, then generating a transmutation of said at least one transition metal into another transition metal and proton emission towards the radioactive material, said radioactive material being at least partially deactivated,
Removing thermal energy from the reactor.

Radioactivity reduction together with heat generation is obtained.

In a subsequent step, the dusty compound can be removed from the reactor. The removed dusty compound can be handled as a non radioactive material. The removed dusty compound can be used again in the process or separated into fractions, for example into species, to obtain the same composition as at the beginning of the process. A part of the species that has been obtained during the process can be removed and the species that has been consumed during the process can be completed.

The radioactive material will now be designated as the “treated material”. The treated material can be removed from the reactor. The removed radioactive material can either be handled as a non radioactive material, or be separated by a chemical process into a non radioactive part and a radioactive part. Said radioactive part, if any, can be submitted again the above method. In most of the cases, it is advisable to have a treatment strong enough to obtain a non radioactive treated material. The material can be classified as non radioactive with reference to standards, such as IAEA standards.

In an embodiment, the method comprises generating an electric field in the chamber, the electric field being applied to the dusty compound and the radioactive material.

In an embodiment, an exothermic transmutation method for at least partially deactivating radioactive material, the method comprising the steps of:
Arranging a dusty compound comprising at least a transition metal in a chamber of a reactor;
Arranging the radioactive material in said chamber, the radioactive material being close to or mixed with the dusty compound;
Providing hydrogen in contact with the dusty compound and with the radioactive material at a pressure higher than the ambient pressure;
Generating an electric field in the chamber, the electric field being applied to the dusty compound and the radioactive material;
Energizing the dusty compound by ultrasonic waves, then generating a transmutation of said at least one transition metal into another transition metal and proton emission towards the radioactive material, said radioactive material being at least partially deactivated,
Removing thermal energy from the reactor.

In an embodiment, the method comprises heating the dusty compound and the radioactive material.

In an embodiment, the radioactive material is a nuclear waste. The method allows for efficient radioactivity reduction.

In an embodiment, the nuclear waste is a fission product. The method is adapted to long life fission products. Said long life fission products were most expensive to retreat before.

In an embodiment, the nuclear waste is a medical/industrial nuclear waste. Medical radio sources are used for imaging. Industrial radio sources are used for non destructive inspection. Large amounts of medical/industrial nuclear waste are produced and should be retreated.

In an embodiment, the nuclear waste is a mining waste. Mining wastes are abundant and have a great variability of composition. As a consequence, the known treatments are expensive and/or not practiced. In some cases, a simple burying is made. In other cases a mixing with dead grounds is made. These are not treatments and let radioactivity in the soil, often not far from surface and liable to be lixiviated. As mining wastes generally have a great variability of composition, it is not easy to determine the suitable known treatment. The method is well suited for mining waste because the same compound composition can be used for various mining waste compositions. If necessary, mining wastes are burned before deactivation to remove biological products therefrom.

In an embodiment, the method comprises heating the chamber at an initial temperature. Heating can be made with an electrical resistance. The initial temperature can be in the range 100-140° C.

In an embodiment, the method comprises a step of removing air from the chamber. Removing air may take place before introducing hydrogen. Removing air can be made with a vacuum pump. Otherwise, removing air may take place during and by introducing hydrogen. In other terms a air flush takes place. Removing air sharply increases the efficiency of the process.

In an embodiment, the dusty compound comprises Ni and Fe, Ni atoms being transmuted into Cu, particularly into non radioactive isotopes of Cu.

In an embodiment, the dusty compound comprises 50% to 95% Ni and 5% to 50% Fe in mass. It has been experimentally tested.

In an embodiment, the dusty compound comprises 70% to 90% Ni and 10% to 30% Fe in mass.

In an embodiment, the dusty compound comprises 1% to 10% Cu in mass. It has been discovered that Cu was enhancing radioactivity reduction. As the Cu quantity is increasing when Ni is transmuted into Cu, the same compound can be used several times until the Cu percentage become too high.

In an embodiment, the dusty compound comprises 2 to 7% Cu in mass. Preferably, an initial dusty compound comprises 2-3% Cu and a final dusty compound comprises 6-7% Cu. A dusty compound is “final” when used for the last time in the process. Afterwards, it is removed from the method. Cu can be separated to decrease the Cu content and obtain a regenerated initial dusty compound.

In an embodiment, the Cu of the dusty compound has at least 99% particles of an average size between 10 and 100 μm, preferably between 10 and 50 μm. The chosen grain size of Cu reduces the duration of the process and the energy to be provided.

In an embodiment, the Cu of the dusty compound has at least 99.9%, particles of an average size between 10 and 100 μm, preferably between 10 and 50 μm.

In an embodiment, the Ni of the dusty compound has at least 99% particles of an average size not greater than 10 μm.

In an embodiment, the Ni of the dusty compound has at least 99.9%, particles of an average size not greater than 10 μm.

In an embodiment, the Fe of the dusty compound has at least 99%, particles of an average size not greater than 10 μm.

In an embodiment, the Fe of the dusty compound has at least 99.9%, particles of an average size not greater than 10 μm.

In an embodiment, the Ni of the dusty compound has at least 99% particles of an average size not greater than 5 μm.

In an embodiment, the Ni of the dusty compound has at least 99.9% particles of an average size not greater than 5 μm.

In an embodiment, the Fe of the dusty compound has at least 99% particles of an average size not greater than 5 μm.

In an embodiment, the Fe of the dusty compound has at least 99.9% particles of an average size not greater than 5 μm.

In an embodiment the dusty compound comprises 25% to 40% graphite in mass, preferably 30 to 40%. The graphite may have 99% particles of an average size not greater than 10 μm.

In an embodiment the dusty compound comprises 10% to 15% Fe, 80 to 85% Ni and 2 to 5% Cu in mass.

In an embodiment the dusty compound comprises 5% to 10% Fe, 57 to 65% Ni, 1 to 3% Cu and 25 to 30% graphite in mass.

In an embodiment the dusty compound comprises 10% to 15% Fe, 75 to 80% Ni, 1 to 3% Cu and 8 to 15% Cr in mass.

Preferably, the dusty compound is homogenized.

In an embodiment, the closed container is essentially made of steel, preferably containing at least 1% Cr in mass, more preferably a stainless steel.

In an embodiment, the pressure in said chamber is greater than 5×10⁵ Pa, said chamber containing at least 99% H₂.

In an embodiment, the pressure in said chamber is between 5×10⁵ Pa and 20×10⁵ Pa, preferably between 10×10⁵ Pa and 15×10⁵ Pa.

In an embodiment, hydrogen is provided before heating and stay in the chamber during the subsequent steps. Hydrogen is removed before removing the dusty compound from the reactor.

In an embodiment, the initial temperature is between 80 and 200° C., preferably between 100 and 150° C.

In an embodiment, the dusty compound comprises a voluntary addition of Cr.

In an embodiment, the dusty compound comprises up to 15% Cr in mass.

In an embodiment, the same dusty compound composition is used for various radioactive materials. As an example the same dusty compound composition is used for waste containing Co⁶⁰, U²³⁵ and Cs¹³⁷.

In an embodiment, the same dusty compound is used for a plurality of radioactive material deactivations. The dusty compound is non radioactive after completion of the method.

In an embodiment, the electric field is essentially static.

In an embodiment, the electric field is between 20 and 30000 volts/m.

In an embodiment, the radioactive material is a powder having at least 99%, preferably 99.9%, particles of an average size not greater than 10 μm.

In an embodiment, the radioactive material is a powder having at least 99%, preferably 99.9%, particles of an average size not greater than 5 μm.

In an embodiment, the ratio of dusty compound/radioactive material is between 3/1 to 6/1 in atom number.

In an embodiment, the hydrogen is deprived of voluntary addition of deuterium and tritium.

In other terms, natural hydrogen is used. There no need of hydrogen isotopic separation.

In an embodiment, the reactor comprises chamber walls comprising at least one of steel, stainless steel and ceramic. Preferably, the chamber walls are made of stainless steel.

In an embodiment, the ultrasonic waves have a frequency between 250 and 600 kHz.

In an embodiment, the ultrasonic waves are generated by a generator having a power between 400 and 2000 W. The power is the electric power needed by the generator.

In an embodiment, removing thermal energy from the reactor is made by gas cooling.

In an embodiment, removing thermal energy from the reactor is made by liquid cooling.

In an embodiment, the electric field and the ultrasonic waves are generated after heating the chamber at said initial temperature, heating being maintained during a first part of a electric field and ultrasonic waves generation period, heating being stopped at the end of said first part, removing thermal energy starting after said first part.

In an embodiment, the initial temperature is between 100 and 140° C.

In an embodiment, the duration of the above steps for a 99% radioactivity decrease is between 5 and 10 hours.

In an embodiment, an electric field and ultrasonic waves generation period has a duration between 5 and 10 hours.

The characteristics and advantages of the invention will be explained in the following description, made with reference to the accompanying drawings.

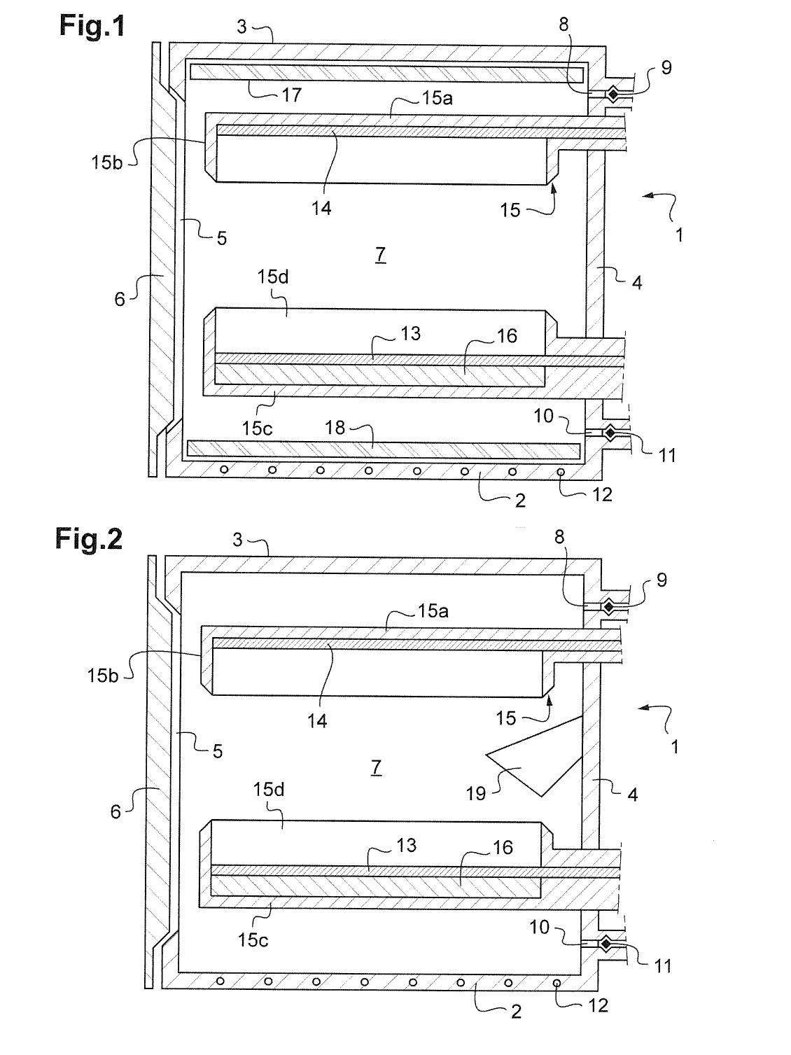

FIG. 1 is an axial cross section of a reactor with ultrasonic generator and heater for use of the method of the invention,

FIG. 2 is an axial cross section of a reactor with ultrasonic generator and microwave generator for use of the method of the invention,

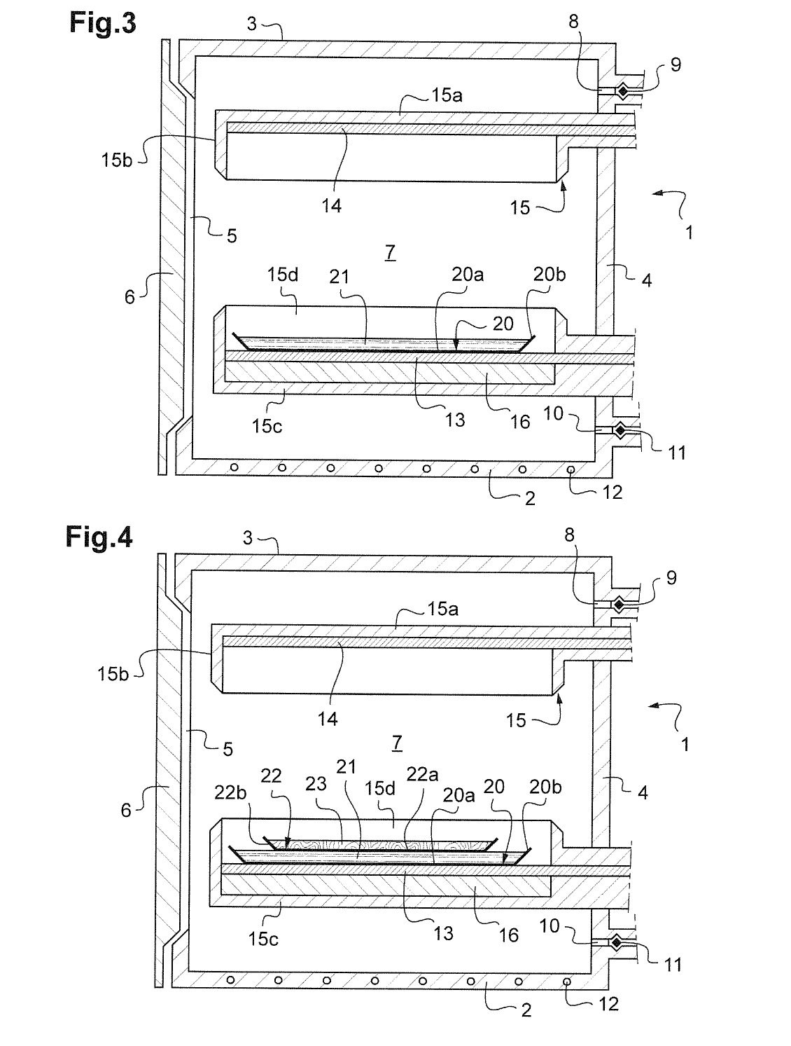

FIG. 3 is an axial cross section of the reactor of FIG. 1, with a cup of dusty compound,

FIG. 4 is an axial cross section of the reactor of FIG. 1, with a cup of dusty compound and a cup of radioactive material.

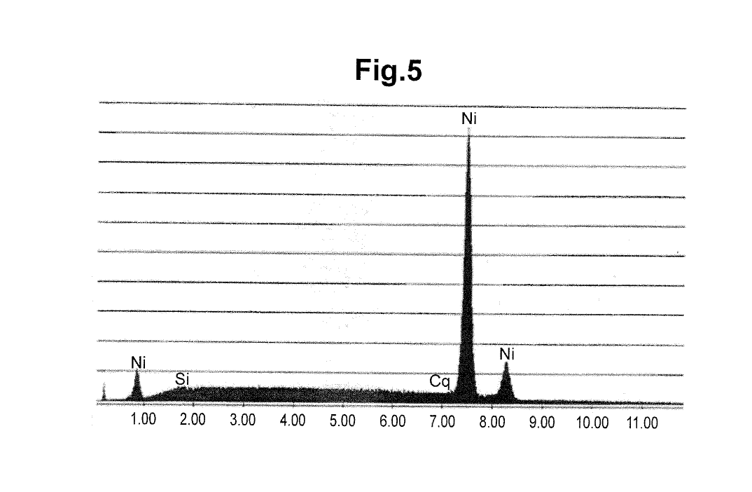

FIG. 5 is a diagram of a spectral analysis made on the treated material of Experiment 1.

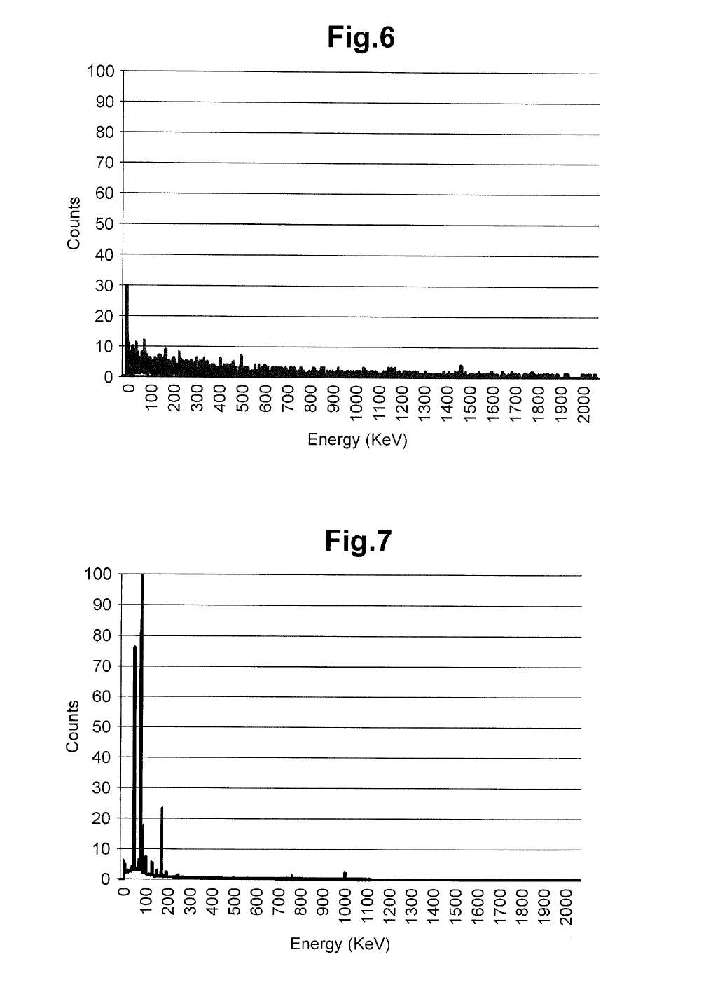

FIG. 6 is a diagram counts/energy of a measure of gamma rays of natural ambiance of Experiment 2.

FIG. 7 is a diagram of a measure counts/energy of gamma rays of the fission waste material of Experiment 2.

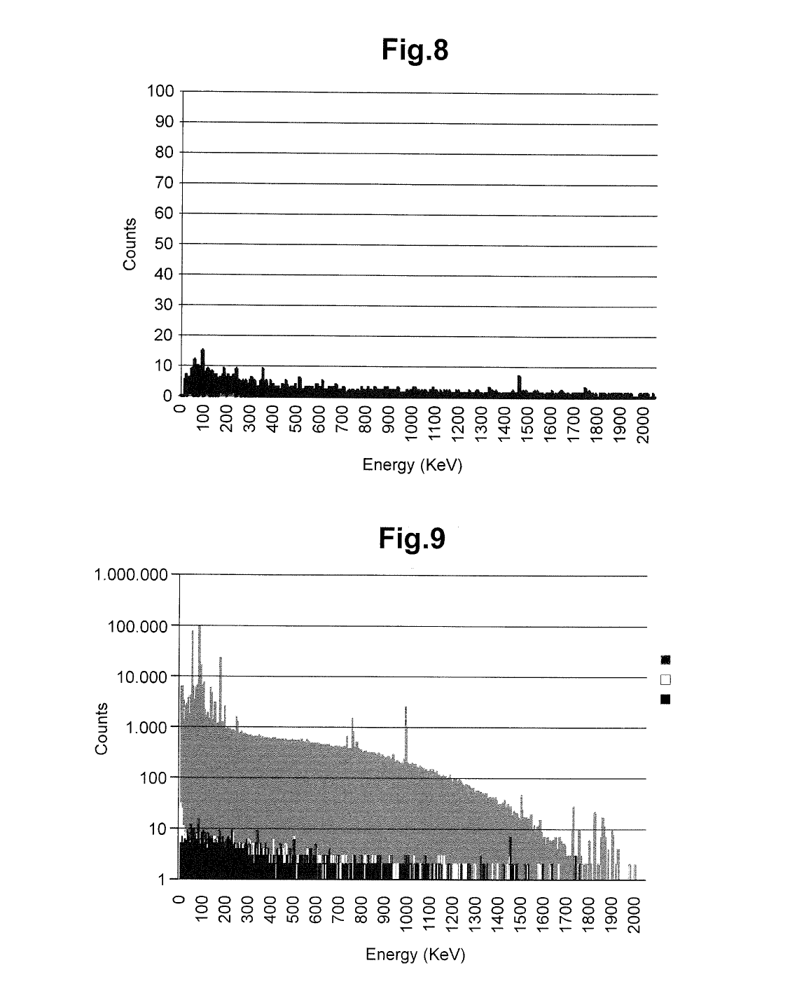

FIG. 8 is a diagram of a measure counts/energy of gamma rays of the treated material of Experiment 2.

FIG. 9 is a comparative diagram showing the results of the three measures of FIGS. 6-8.

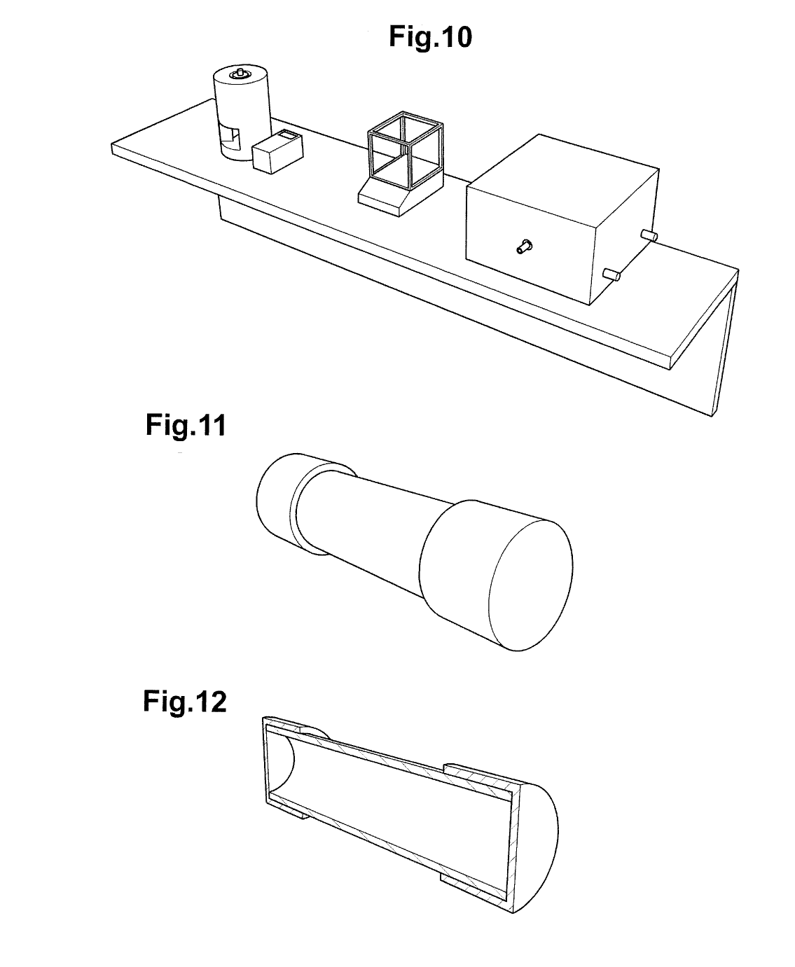

FIG. 10 is a schematic view in perspective of the apparatuses used in Experiment 4.

FIG. 11 is a schematic view in perspective of the container used in Experiment 4.

FIG. 12 is a schematic view in exploded perspective of the container used in Experiment 4.

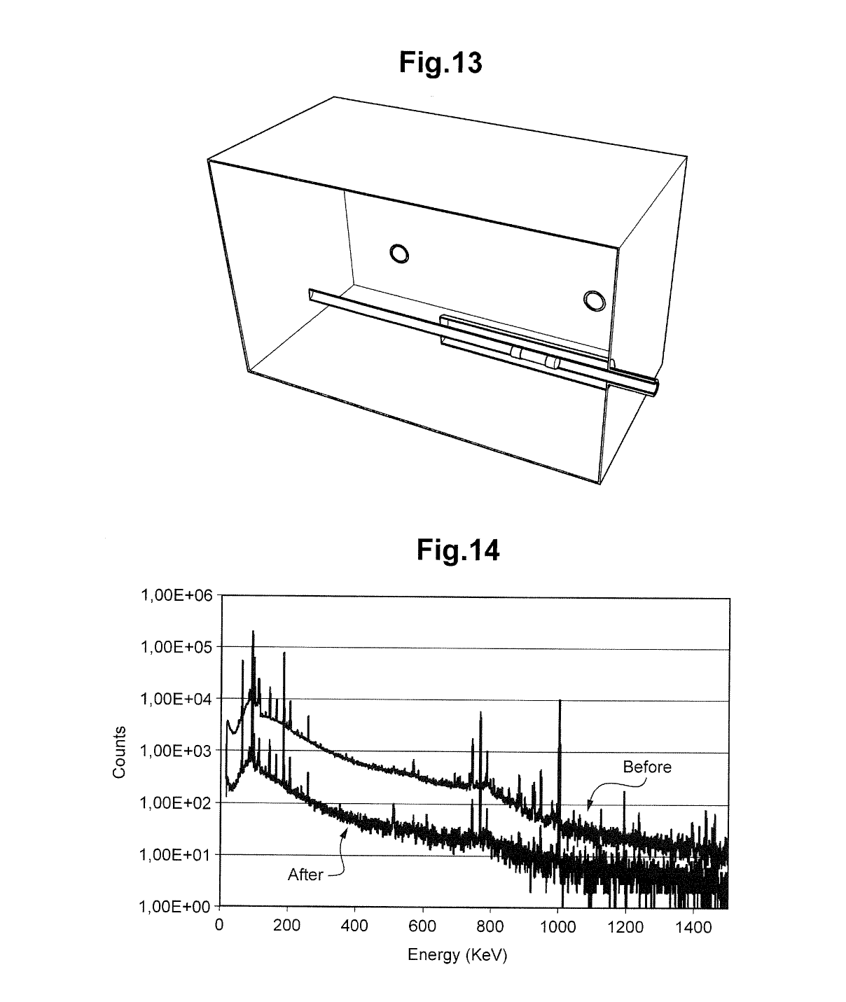

FIG. 13 is a schematic view in exploded perspective of the reactor used in Experiment 4.

FIG. 14 is a comparative diagram of a measure counts/energy of gamma rays of the fission waste material and of the treated material of Experiment 4.

The accompanying drawings will not only serve to complete the invention but also, if necessary, to contribute to its definition.

In order to improve energy production and waste treatment, the inventor made long researches on the low energy transmutation assisted by transition metals. The following species has been identified as suitable to assist transmutation: Sc, Ti, V, Cr, Mn, Fe, Co, Ni, Zn, Y, Zr, Nb, Mo, Tc, Ru, Rh, Ag, Cd, Hf, Ta, W, Re, Os, Ir, Pt, Au, lanthanides and actinides. They can be industrially pure or alloyed. A low presence of Cu within the compound of metal powder appears experimentally to be favorable. However, Cu is not a driver metal. Cu has a function of enhancing the transmutation.

The inventor was looking for decontaminating nuclear wastes while producing energy in a safe process that issues into inactive materials, under low or medium temperatures and industrially scalable devices.

WO0129844 concerns generating energy from a hydrogen absorbing material submitted to electric current pulses.

WO2010058288 proposes generating energy from nuclear reactions between hydrogen and a metal under a strong induction 1-70000 Gauss and an electric field 1-300000 v/m.

WO2013/108159 discloses a nuclear reactor with a radiation source to irradiate a colloidal mixture.

On FIG. 1, a reactor 1 comprises a lower wall 2, an upper wall 3, a peripheral wall 4 defining an aperture 5 and a door 6 able to close the aperture 5. The reactor 1 defines a tight chamber 7 when the door 6 is closed. Insertion of solid material in the chamber 7 is possible through the aperture 5 when the door 6 is open. The reactor 1 forms a closed space. The reactor walls 2, 3, 4 and door 6 are essentially made of steel, preferably containing at least 1% Cr in mass. The reactor walls 2, 3, 4 and door 6 can be made of stainless steel. The reactor 1 is adapted to an internal pressure above 10⁶ Pa, preferably 2*10⁶ Pa at 20° C. The reactor 1 is adapted to an average internal temperature between 100 and 800° C., and localized internal temperature between 200 and 1000° C. The parts of the reactor 1 being in the chamber 7 and described below are able to withstand the above temperature, the above pressure and a H₂ atmosphere.

The reactor 1 is provided with a first opening 8 connected to a vacuum pump, not shown on the figures, and a first valve 9. The first opening 8 is bored into the peripheral wall 4. The vacuum pump is used to remove air from the chamber 7 after closing the door. The reactor 1 is provided with a second opening 10 connected to a hydrogen source, not shown on the figures, and a second valve 11. The hydrogen source can be a pressurized H₂ container. The hydrogen source is used to introduce hydrogen in the chamber 7 after air removal. The hydrogen source is configured to set the pressure in said chamber 7 above 5×10⁵ Pa, preferably at 10⁶ Pa, at ambient temperature. The chamber 7 may contain at least 99% H₂, preferably at least 99.9% H₂.

In a variant, the first opening 8 is connected to ambient atmosphere and is equipped with a valve. The hydrogen source is used to make a hydrogen flush expelling oxygen out of the chamber 7. A nitrogen source can be provided to make a nitrogen flush to avoid mixing hydrogen and air.

The reactor 1 comprises a cooling member 12. The cooling member 12 can be incorporated into at least one wall of the reactor 1 to constitute at least one cooling wall. The cooling member 12 may comprise tubes in which a coolant circulates. On FIG. 1, the lower wall 2 is equipped with a cooling member 12.

The reactor 1 comprises an electric field generator. The electric field generator comprises an anode 13 and a cathode 14 arranged in the chamber 7. The anode 13 and the cathode 14 have facing surfaces. Here, the anode 13 and the cathode 14—the electrodes—are mounted one in an upper part and the other in a lower part of the chamber 7. Here the anode 13 is in the lower part and the cathode 14 is in the upper part. The anode 13 and the cathode 14 may be substantially horizontal as well as the facing surfaces. In another embodiment, the anode 13 and the cathode 14 are substantially vertical. The electric field generator comprises an insulation part 15 surrounding the anode 13, the cathode 14 and the region between the facing surfaces of the anode 13 and the cathode 14. The insulation part 15 prevents short circuiting the electric field with one of the walls of the reactor 1. The electric field generator comprises a high voltage source outside the reactor 1 and insulated wires connecting the voltage source to the anode 13, and to the cathode 14. The insulation part 15 comprises an upper plate 15a arranged between the upper wall 3 and the anode 13 and in contact with the anode 13, and an upper cylindrical rim 15b protruding downwardly. The upper plate 15a and the upper cylindrical rim 15b form an upper half shell. The insulation part 15 can be made of ceramic. The insulation part 15 is made in a material resistant to the temperature of the chamber 7 during treatment and compatible with a H₂ ambiance.

In a symmetrical arrangement, the insulation part 15 comprises a lower plate 15c arranged between the lower wall 2 and the cathode 14 and in contact with the cathode 14, and a lower cylindrical rim 15d protruding upwardly. The lower plate 15c and the lower cylindrical rim 15d form a upper half shell.

A space remains between the half shells, i.e. between the end portions of the upper cylindrical rim 15b and the lower cylindrical rim 15d. “Cylindrical” is used in its geometrical meaning, the rim being circular, square or polygonal in cross section. Said space is sufficient for moving at least two recipients therethrough, at least one for the nuclear waste and at least one for a driver compound 21. The shape of the half shells is configured to let the electric field lines as parallel as possible. Applying parallel electric field lines improves the homogeneity of the treatment and reduces the occurrence and the size of hot points in the nuclear waste. Hot points of nanometric size leading to agglomeration of atoms by partial fusion may occur. Hot points of large size, for example from micrometric to millimetric, could be detrimental to the efficiency of the treatment. A post-crushing of the treated waste may be required in case of large hot points above the fusion temperature of the treated waste.

The reactor 1 comprises an ultrasound generator 16. The ultrasound generator 16 is arranged in the concavity of the lower half shell of the insulation part 15 of the electric field generator. The ultrasound generator 16 is arranged between the lower electrode 13 and the lower plate 15c of the insulation part 15, along a vertical axis. The ultrasound generator 16 is surrounded by the lower cylindrical rim 15d of the insulation part 15, in a horizontal plane. The ultrasound generator 16 has a nominal electric power comprised between 400 and 2000 W. The power is the electric power needed by the generator. The ultrasound generator 16 has a frequency comprised between 250 and 600 kHz, for example 300 kHz. The frequency can be fixed.

In the embodiment of FIG. 1, the reactor 1 comprises two electric heaters 17 and 18. One of the electric heaters is arranged in a lower region of the chamber 7. The lower electric heater 18 stays on the lower wall 2 of the reactor 1. The other of the electric heaters is arranged in an upper region of the chamber 7. The upper electric heater 17 is in contact with the upper wall 3 of the reactor 1. To enhance heating of the chamber 7, a small space remains between the lower electric heater 18 and the lower wall 2 and between the upper electric heater 17 and the upper wall 3. The small space ensures thermal insulation. The small space can obtained by spacing legs provided on the surface of the electric heater facing the corresponding wall. In another embodiment, a layer of insulating material is arranged between said surface of the electric heater and the corresponding wall. As shown on FIG. 1, the electric heater 17, 18 is covering most of the surface of the corresponding wall, for example more than 90%. Homogeneity of the heating is obtained.

In the embodiment of FIG. 2, the reactor 1 comprises a microwave emitter 19. The microwave emitter 19 is supported by the peripheral wall 4. The microwave emitter 19 is opposite the door 6. The microwave emitter 19 has a waveguide protruding in the chamber 7. The other parts of the microwave emitter 19 can be arranged within the chamber 7. In another embodiment, the other parts of the microwave emitter 19 are arranged outside the chamber 7 and connected to the waveguide through a tight wall-bushing. The waveguide has a frusto-conical shape with a large emitting end. The waveguide is configured to emit microwaves in the chamber 7 towards a receiving region in which the nuclear waste is intended to be present. In other terms, the nuclear waste and the driver compound 21 will stay in the microwave receiving region during the process. The cables for feeding the above cited electrical energy receivers are not shown on the figures for clarity reasons.

As shown on FIG. 3, the reactor 1 accommodates a container 20 of driver compound 21. The container 20 stays on the surface of the lower electrode. The container 20 is cup shaped. The container 20 comprises a disc shaped base wall 20a and a circular rim 20b surrounding the base wall. The rim 20b is frusto-conical with an angle between 30 and 60°. The container 20 may be made in one part. The container 20 may comprise copper or brass. The container 20 may consist of copper or brass. In a variant, the container 20 may consist of steel. The thickness of the container 20 can be chosen from 0.4 mm to several millimeters. The thickness of the container 20 can be selected according to the mass of driver compound 21 therein and to thermal conductivity requirements. In the tests, a copper cup of 0.5 mm thickness has been used. In addition to containing, the container 20 also homogenizes the temperature within the driver compound 21.

The container 20 houses a layer of driver compound 21. The thickness of the layer of driver compound 21 is not greater than the height of the rim. The layer of driver compound 21 has a substantially constant thickness. The layer thickness can be between 2 to 12 mm. The driver compound 21 is evenly spread over the surface of the base wall of the container 20. The driver compound 21 has a uniform surface facing the upper electrode, uniform being understood within a macroscopic meaning. The driver compound 21 can be pressed or not. The driver compound 21 is substantially deprived of material liable to enter into chemical reaction with H₂, for example oxygen.

In the tests, the driver compound 21 comprises a powder having a purity not less than 99%. Each metal of the powder may have a purity not less than 99%. Metallic impurities less than 1% in mass can be accepted. Particularly in case of non metallic impurities, the purity of the powder is preferably not less than 99.9%.

The driver compound 21 has generally a granulometry less than 5 μm. However, copper powder present as reaction enhancer has a granulometry less than 20 μm in the experiments that have been made. In a variant, the copper particles have a diameter comprised between 10 and 40 μm. In other terms, each metal grain but copper has a granulometry less than 5 μm in the experiments that have been made.

The driver compound 21 is non radio-active. In other terms, the driver compound 21 has a radio-activity not above the fundamental natural level.

In one embodiment, the dusty compound comprises Ni and Fe. The composition can be 50% to 95% Ni and 5% to 50% Fe in mass. The composition can be 70% to 90% Ni and 10% to 30% Fe in mass. Ni atoms are transmuted into Cu during the process.

In one embodiment, the dusty compound comprises 1% to 10% Cu in mass. In one embodiment, the dusty compound comprises 2 to 7% Cu in mass. Cu is part of the dusty compound while not being as such a driver of the transmutation reaction. Cu is also a product of the transmutation reaction from Ni. Dusty copper enhances the thermal conductivity of the dusty compound.

In one embodiment, the Cu of the dusty compound has at least 99%, preferably 99.9%, particles of an average size between 10 and 100 μm, preferably between 10 and 50 μm, more preferably between 10 and 20 μm.

In one embodiment, the Ni of the dusty compound has at least 99%, preferably 99.9%, particles of an average size not greater than 10 μm.

In one embodiment, the Fe of the dusty compound has at least 99%, preferably 99.9%, particles of an average size not greater than 10 μm.

In one embodiment, the Ni of the dusty compound has at least 99%, preferably 99.9%, particles of an average size not greater than 5 μm.

In one embodiment, the Fe of the dusty compound has at least 99%, preferably 99.9%, particles of an average size not greater than 10 μm.

An addition of graphite may be done in the dusty compound. The dusty compound may comprise 25% to 40% graphite in mass, preferably 30 to 40%. Graphite is useful when heating by micro-wave. Graphite may have particles of an average size not greater than 10 μm.

An addition of Chromium may be done in the dusty compound. The same dusty compound composition may be used for various radioactive materials. In other terms, the dusty compound composition is, for some extent, independent of the radioactive material composition.

In one embodiment, the dusty compound comprises 10 to 15% Fe, 80-85% Ni and 2-5% Cu in mass. Such a compound has been tested with a heating by electric heater.

In one embodiment, the dusty compound comprises 5 to 10% Fe, 57-65% Ni, 1-3% Cu and 25-30% graphite in mass. Such a compound has been tested with a heating by micro-wave.

In one embodiment, the dusty compound comprises 10 to 15% Fe, 75-80% Ni, 1-3% Cu and 8-15% Cr in mass. The compound has been tested with a heating by a laser.

As shown on FIG. 4, the reactor 1 accommodates a first container 20 of driver compound 21 and a second container 22 of nuclear waste 23. The second container 22 stays on the upper surface of the driver compound 21. The second container 22 is cup shaped. The second container 22 has a diameter smaller than the diameter of the first container 20. The second container 22 supported by the driver compound 21 is spaced away from the first container 20. The second container 22 comprises a disc shaped base wall 23a and a circular rim 23b surrounding the base wall 23a. The rim 23b is frusto-conical with an angle between 30 and 60°. The second container 22 may be made in one part. The second container 22 may comprise copper or brass. The second container 22 may consist of copper or brass. The second container 22 may consist of a laminated leaf of copper. The thickness of the second container 22 can be chosen from 0.4 mm to several millimeters. The thickness of the second container 22 can be selected according to the mass of nuclear waste 23 therein and to thermal conductivity requirements. In the tests, a copper cup of 0.5 mm thickness has been used. In addition to containing, the second container 22 also homogenizes the temperature within the driver compound 21, within the nuclear waste 23 and between the nuclear waste 23 and the driver compound 21. However, reducing the thickness of the second container 22 enhances the efficiency of the process.

The second container 22 houses a layer of nuclear waste 23. The thickness of the layer of nuclear waste 23 is not greater than the height of the rim. The layer of nuclear waste 23 has a substantially constant thickness. The layer thickness can be between 2 to 12 mm. The nuclear waste 23 is evenly spread over the surface of the base wall of the container. The nuclear waste 23 has a uniform surface facing the upper electrode, uniform being understood within a macroscopic meaning. The nuclear waste 23 can be pressed or not. In a variant, a third container of driver compound 21 and a fourth container of nuclear waste are provided in the reactor 1, superposed to the first and second container 22s and so on.

In an embodiment, the second container 22 is thinner than 0.4 mm, for example a thickness chosen between 0.15 and less than 0.4 mm. The layer of nuclear waste 23 may be between 2 to 4 mm for a reduced weight allowing to move the loaded second container 22. In a variant, the second container 22 is empty when inserted in the chamber 7 and the nuclear waste 23 is loaded in the second container 22 staying in the chamber 7. In another variant, the rim of the second container 22 is reinforced. The reinforcement may comprise a folded second layer of the copper leaf forming the second container 22 to form a double sheet rim. The reinforcement may comprise an edge protruding from the rim and perpendicular to the rim. The edge may be solid with rim. The reinforcement may comprise a steel ring secured to the rim. In another variant, an intermediate support may be provided under the second container 22 during insertion of the second container 22 and removed after insertion into the chamber 7; the intermediate support may be provided under the second container 22 before removal thereof.

In the tests, the nuclear waste 23 is dusty. The nuclear waste 23 consists of a powder containing one or several radioactive elements. The nuclear waste 23 is substantially deprived of carbon. Carbon is as low as reasonably possible as it slows down the reaction. Carbon can be extracted by burning, particularly in the case of mining wastes containing organic materials. The nuclear waste 23 is substantially deprived of material liable to enter into chemical reaction with H₂.

The nuclear waste 23 has generally a granulometry less than 5 μm. The mass of driver compound 21 and the mass of nuclear waste 23 are in a ratio between 3/1 to 6/1. An excess of driver compound 21 delays the activation of the process. An inhibiting effect has not been detected today.

The first container 20 loaded with driver compound 21 and the second container 22 loaded with nuclear waste 23 may be inserted sequentially in the chamber 7. In a variant, the first container 20 loaded with driver compound 21 and the second container 22 loaded with nuclear waste 23 may be inserted together in the chamber 7.

Owing to the process, the transmutation is strongly accelerated with regard to the natural transmutation. The theory underlying the process is completely understood today. The inventor has experimented that the process allows for a strong increase in deactivation speed.

Nuclear waste deactivation together with heat generation is obtained by submitting the nuclear waste to a pressurized hydrogen atmosphere at medium temperature and close to a metallic driver under an electric field. Some specialists use the expression “neutronic cloud” to describe the effect of a neutron availability caused by the ultrasounds on the driver metals, especially iron. However, such an expression is criticized by other specialists.

Energy is provided to heat the hydrogen, the nuclear waste and the metallic driver at the beginning of the process. Heating can be provided by an electric heater and/or by a microwave generator and/or a laser. The electric field is polarizing the particles of nuclear waste and the metallic driver. Polarization enhances the transfer of protons from the nuclear waste to the metallic driver. The phenomenon involves the transfer of protons activated by ultrasound. After some time, heating is stopped and the process is exothermic. The electric field is maintained. Heat can be removed by the cooling member 12. The electric field is maintained for a duration either preset or depending on measured parameters, for example radioactivity, removed energy, sum of temperatures. The duration can be 1-10 hours. The electric field generator is stopped. Hydrogen is removed from the chamber 7. A nitrogen flush can be made to avoid mixing hydrogen and air. If necessary, cooling is maintained until a temperature making easy the removal of the treated nuclear waste is reached, for example 40° C. The treated nuclear waste is no more radioactive. The treated nuclear waste can be used as ordinary metal powder.

In case the process should be interrupted, switching off the electric field generator causes a quick decrease of the transmutation. It is good to switch off the micro-wave generator, if any. It is also recommended to switch off the ultra-sound generator, if any. The electric heater or heaters may be switched off. Cooling is maintained. In other terms, any energy input into the reactor 1 is switched off. However, setting the electric field generator to an inverted electric field of absolute value significantly lower to the absolute value of the electric field during the deactivation phase is possible. Hydrogen may be removed from the chamber 7 by a nitrogen flush, preferably at low temperature.

Turning now on the steps of the process, the metallic driver is prepared to have a purity not lower than 99% and a granulometry<10 μm. The experiments show a greater efficiency with a granulometry<5 μm. The dusty compound which has a meaning larger than metallic driver, comprises the metallic driver and, possibly, a metal that is not a driver per se, but increase the transmutation number. A metal that is not a driver per se could act as a catalyst. It has discovered that the presence of Copper is favorable. 1 to 5% Cu in the initial dusty compound is a selected range. After several uses of the dusty compound, the content of Cu may reach 7% without negative effect. Above 7%, the Cu content may be reduced by a chemical process. The metallic driver has been experimented with Fe, Ni. Other metals are possible, if solid, for example Zn and Cr. The dusty compound may also comprise an addition of graphite to enhance thermal conductivity and therefore homogeneity of temperature in the dusty compound. All materials constituting the dusty compound are mixed to obtain a homogenous compound. The dusty compound is poured into the first container 20.

At the same time or not, the nuclear waste is prepared to have a granulometry<10 μm, preferably <5 μm. Carbon, if any, is removed from the nuclear waste. The nuclear waste may be metallic or not. The nuclear waste is mixed to obtain an homogenous product. The nuclear waste is poured into the second container 22.

After opening the door 6 of the reactor 1, the first container 20 is moved into the chamber 7. The first container 20 is laid down on the anode surface. The lower surface of the first container 20 is in contact with the upper surface of the anode 13.

The second container 22 is moved into the chamber 7. The second container 22 is laid down on the driver compound 21 staying in the first container 20. The lower surface of the second container 22 is in contact with the upper surface of the driver compound 21. The door 6 of the reactor 1 is closed in a tight manner. Nitrogen is introduced into the chamber 7 by an opening of the reactor 1 with another opening to ambient atmosphere remaining open. Oxygen content is reduced below 3%. A nitrogen flush is made. Nitrogen flush avoids the risk of chemical reaction between H₂ and O₂ of air. Afterwards, hydrogen is introduced into the chamber 7 by an opening of the reactor 1 with said other opening to ambient atmosphere remaining open. Nitrogen content is reduced below 3%, preferably below 1%. A hydrogen flush is made. The hydrogen flush is longer that the nitrogen flush. Hydrogen should occupy the available space of the chamber 7 as deeply as possible. As the first container 20 is larger than the second container 22, hydrogen is in contact with the dusty compound between the first container 20 and the second container 22. Hydrogen penetrates into the powder of nuclear waste and into the powder of dusty compound. As H₂ is a small molecule, the powders may be very fine. The dusty compound is saturated with hydrogen. The nuclear waste is saturated with hydrogen.

The electric field generator is switched on. The electric field is 1000 V/m or more. The electric field is chosen as a function of the chamber size and of the thickness of dusty compound and of nuclear waste in the first and second containers respectively.

The ultrasound generator 16 is switched on. The ultrasound generator 16 is set at the frequency 300 kHz. Alternatively, the frequency is chosen as a function of the metallic driver. The energy flux may be not less than 1.3 Wm⁻². The ultrasound generator 16 is operating at a level greater than the Minkowski threshold of the nuclear forces. The Minkowski threshold has to be understood as the value of the mechanical waves enabling to interact with the subatomic level.

Heat is provided to the chamber 7 by at least one of the electric heaters, microwave generator or laser. With the electric heaters the chamber 7 is heated up to 90° C. Then, the ultrasound generator 16 is switched on. The transmutation step starts around 180° C. of average temperature in the chamber 7. The electric heaters may be switched off.

With a microwave generator, the ultrasound generator 16 is switched on simultaneously. The increase of temperature is slower than with electric heaters. The transmutation step starts around 180° C. of average temperature in the chamber 7. The microwave generator may be switched off. The transmutation step is steady.

With a laser, the ultrasound generator 16 is switched on before. The increase of temperature is stronger than with electric heaters. However, the hydrogen temperature is less representative of the temperature of the dusty compound and of the nuclear waste than in the previous embodiments. The transmutation step starts sharply. The laser may be switched off. “Laser” is used here as a synonym of “laser emitter”.

However, heating is optional. The transmutation step is also obtained without dedicated heater. In such an embodiment, the transmutation step starts with the electric field and ultrasounds directed towards the nuclear waste. Ultrasounds provoke a mechanical movement between the grains of nuclear waste and of the dusty compound and a slight increase of temperature.

During the transmutation step, the temperature in the chamber 7 may be around 360° C. Cooling may start at a temperature chosen between 180° C. and 360° C. More generally, cooling starts after the process becomes thermally self-sufficient. The temperature of the dusty compound and of the nuclear waste may be in the range 400-600° C. The temperature of the dusty compound and of the nuclear waste is similar. Hot points may be at higher temperatures, such as 1000° C. or 1400° C., at a microscopic scale. Hot points may create local melting of metal grains of powder. The high thermal conductivity of the dusty compound and of the containers, possibly of the nuclear waste, reduces the size and the duration of the hot points.

At the end of the transmutation step, either after a preset duration, or when relevant parameters have been reached, the electric field generator is switched off. The ultrasound generator 16 is switched off. Cooling is maintained to obtain a safe temperature. Hydrogen is flushed by nitrogen. Then, the door 6 is open. The deactivated nuclear waste is removed.

The dusty compound may stay therein and be used again several times for deactivating a fresh nuclear waste. If a Cu content ceiling level is attained or estimated, the dusty compound is removed. The Cu enriched dusty compound may be chemically treated to remove a part of the Cu, then used again in the process.

Generally, there is no voluntary generation of magnetic field.

### Experiment 1

An experiment has been made to treat ⁶⁰Co often present in medical wastes. The hypothesis of transmutation of ⁶⁰Co into stable isotopes ⁶¹Ni or ⁶²Ni is based on measurements. The level of emission of neutrons and of gamma rays of the treated material formerly containing ⁶⁰Co is close to zero. Transmutation would be based on:

⁶⁰Co+p⁺→⁶¹Ni

⁶⁰Co+2p⁺→⁶²Ni

A spectral analysis of the treated material was made with a SEM EDAX instrument. The results are shown on FIG. 5. The spectrum shows the almost exclusive presence of Nickel evidenced by the three peaks designated “Ni”. The position corresponding to Cobalt is indicated by “Co” and reveals a very low content of Co.

A resistance is used as a heater, see FIG. 1. The pressure inside the reactor is approximately 13 bar. The starting temperature measured outside the reactor is approximately 110° C. The duration is approximately 165 minutes. The driver comprises approximately 13 grams of Nickel (Ni) and Iron (Fe) with a particle size less than 5 micrometers. The waste comprises approximately 1 gram of Cobalt-60 (⁶⁰Co) with a particle size less than 5 micrometers. No electrical field has been generated.

### Experiment 2

An experiment has been made to treat a fission waste. As a reference, a first measure of gamma rays of natural ambiance has been made at 9:00, see FIG. 6. The scale of FIG. 7 is 100. At 14 h 25, a measure of gamma rays of the fission waste to be treated, see FIG. 7. The scale of FIG. 7 is 100000. The lecture of FIGS. 6 and 7 is made easier with the table below:

IDENTIFIED NUCLIDES

| Nuclide | Id | Energy | Yield |
|---|---|---|---|
| Name | Confidence | (keV) | (%) |
| RA-226 | 1.00 | 186.2 | 3.3 |
| PA-234 | 0.46 | 94.7 | 15.5 |
| | | 98.4 | 25.1 |
| | | 111.0 | 8.6 |
| | | 131.3 | 20.0 |
| | | 152.7 | 7.2 |
| | | 226.9 | 6.5 |
| | | 569.3 | 10.4 |
| | | 733.0 | 8.5 |
| | | 883.2 | 12.0 |
| | | 946.0 | 20.0 |
| | | 949.0 | 7.8 |
| PA-234M | 0.99 | 766.4 | 0.2 |
| | | 1001.0 | 0.6 |
| TH-234 | 1.00 | 63.3 | 4.5 |
| | | 92.4 | 2.6 |
| | | 92.8 | 2.6 |
| | | 112.8 | 0.3 |
| U-235 | 0.93 | 90.0 | 1.5 |
| | | 93.4 | 2.5 |
| | | 105.0 | 1.0 |
| | | 109.1 | 1.5 |
| | | 143.8 | 10.5 |
| | | 163.4 | 4.7 |
| | | 185.7 | 54.0 |
| | | 202.1 | 1.0 |
| | | 205.3 | 4.7 |

Energy Tolerance: 1,000 keV

At 15:45, the fission waste is transferred into the reactor and the reactor and the measurement apparatuses are ready. The measurement apparatuses includes:
Two temperature probes on the cooling member 12, one upstream, the other downstream;
A flowmeter on the cooling circuit configured to measure the flow of coolant;
A electric power meter to measure the electric energy used for starting and maintaining the process.

The measurement apparatuses are mounted to establish an energy balance of the process. The values have been registered continuously.

A resistance is used as a heater, see FIG. 1. The pressure inside the reactor is approximately 18 bars. The starting temperature measured outside the reactor is approximately 140° C. The driver comprises approximately 27 grams of Nickel (Ni) and Iron (Fe) with a particle size less than 5 micrometers and Copper (Cu) with a particle size less than 10 micrometers. The waste comprises approximately 1.6 grams of hydrate uranyl acetate (CAS n^{o} 6159-44-0) with a particle size less than 5 micrometers. No electrical field has been generated.

At 16:00, the process started. Radioactive emission measurements in ambient atmosphere as well as in the vicinity of the reactor are made. The measurement of radioactivity within the reactor has been made after the end of the experiment.

At 18:35, the process was interrupted.

At 19:15 the treated waste was put into an apparatus for measuring the gamma rays.

At 19:25 the gamma rays emitted by the treated waste were measured and reported on FIG. 8. The scale of FIG. 8 is 100, the same as FIG. 6.

It has been established based on the measure of the natural radioactivity that the gamma rays measurement apparatus was reliable. The measure of the radioactivity of the fission waste shows the presence of radio-nuclides, directly or indirectly by the presence of nuclides of second generation. The measure of the radioactivity of the treated waste shows a very significant gamma ray emission decrease. The residual gamma ray emission of the treated waste is of the same magnitude than the natural radioactivity.

On FIG. 9 established with a logarithmic scale, the gamma ray emission measurements are compared:

d1 09.00: natural radioactivity measurement;
d2 14.25: fission waste radioactivity measurement before treatment;
d3 19.15: waste radioactivity measurement after treatment.

The power balance of the process has been calculated. The energy consumed is 630 Whₑ. The temperature difference between the temperature probes is 2.506° C. during 9240 seconds with a mass flow of 580 kg/h cooling water, see table below:

| | Temperature | Temperature | | Duration | average |
|---|---|---|---|---|---|
| | of water | of water at | | of | ΔT during |
| | at input | output | ΔT | temperature | the test |
| Hour | (° C.) | (° C.) | (° C.) | (s) | (° C.) |
| 16.01 | 22.3 | 25.2 | 2.9 | 540 | |
| 16.10 | 22.2 | 25.4 | 3.2 | 600 | |
| 16.20 | 21.8 | 24.7 | 2.9 | 600 | |
| 16.30 | 21.7 | 24.4 | 2.7 | 600 | |
| 16.40 | 21.6 | 24.0 | 2.4 | 1 500 | |
| 17.05 | 21.4 | 23.5 | 2.1 | 300 | |
| 17.10 | 21.3 | 23.2 | 1.9 | 240 | |
| 17.14 | 21.3 | 23.8 | 2.5 | 2 100 | |
| 17.49 | 21.1 | 23.7 | 2.6 | 1 080 | |
| 18.07 | 21.1 | 23.6 | 2.5 | 1 140 | |
| 18.26 | 20.7 | 22.7 | 2 | 180 | |
| 18.29 | 20.6 | 22.6 | 2 | 120 | |
| 18.31 | 21.9 | 22.4 | 0.5 | 240 | |
| 18.35 | 20.9 | 21.7 | 0.8 | | |

| | | |
|---|---|---|
| Duration of the test | 9 240 | 2.506 |

To simplify, the table shows the temperature values that evolve, upstream as well as downstream. The calculation is made according to table 3 with few approximations. A volume of 1.49 m³ water has been heated of 2.5° C. that corresponds to 4.34 kWh heat. The heat losses of the reactor are neglected while significant due to the non hermetic closure during this experiment. The energy sent to the reactor is 0.63 kWh.

| a | b | c | D = a × b × c | e | f = d × e | g = f: 1000 | h | i = g × h | l | m |
|---|---|---|---|---|---|---|---|---|---|---|
| 2.5065 | 580.0000 | 1.00 | 1.453.7700 | 1.1630 | 1.690.7345 | 1.6907 | 2.5667 | 4.3396 | 0.612 | 7.0907711 |
| ΔT | Water | Specific | Thermic | Conversion | Thermic | Thermic | Test | Thermic | Energy | COP |
| | flow | heat of | energy per | factor | energy | energy | duration | energy | used | |
| | per | water | hour | | per hour | per hour | | produced | during | |
| | hour | | | | | | | during | the test | |
| | | | | | | | | the test | | |
| ° C. | kg/h | | kcal/h | | Whₜ | kWhₜ | h | kWhₜ | kWhₑ | |

As a conclusion, the gamma rays emission spectrum changing towards the spectrum of the natural radioactivity, the exothermic properties of the process as well as the self sustainment after ignition indicates a transmutation reaction.

### Experiment 3

An uranyl acetate powder was mixed up with Nickel (Ni) added before treatment, forming a sample, and put on a support structure. The total weight of the sample was 20.306 g, of which 0.846 g of uranyl acetate. At the end of the test the weight of the sample was 21.290 g, i.e. 0.984 g larger than above. The weight increase may be caused by the contact with dirty gloves. In any case it seems that a consistent loss of uranyl acetate inside the reactor can be excluded. The reactor was according to FIG. 2.

Before the insertion into the reactor, the sample was put inside a copper cylinder positioned around the charging pipe, hiding visually the sample, but allowing the radioactivity measure described below, with the certainty that the no substitution of material was possible.

The gamma ray emission from the positioned sample containing copper was recorded by a Lantanium Tribromide spectrometer. The total counting over 600 seconds in the energy interval 1.8-1534 keV, and the partial counting in the channels between 85.8 and 97.8 keV (i.e. around the ²³⁴Th-doublet at about 93 keV) are reported in the following table:

| | | | | | | Partial | Total |
|---|---|---|---|---|---|---|---|
| Energy | 85.8 | 88.8 | 91.8 | 94.8 | 97.8 | 85.8-97.8 | 1.8-1534 |
| (keV) | | | | | | | |
| Charge | 446 | 576 | 629 | 640 | 413 | 2.704 | 31.770 |
| Background | 257 | 286 | 268 | 260 | 256 | 1.327 | 26.561 |
| Standard | 16 | 17 | 16 | 16 | 16 | 36 | 163 |
| Deviation | | | | | | | |

The ²³⁴Th-doublet at about 93 keV was then positively detected.

After the insertion into the reactor, the same spectrometer was positioned as near as possible to the sample, but no activity above the background was revealed; possibly because some shielding inside the reactor. Therefore there was no possibility of detecting the radioactivity variations during the following process. The reactor was tightly closed. The process was started at 19:30 with electric field and heating. The electrical field is generated by direct current. The electrical field is approximately 10 000 V/m. After 3 hours, i.e. at about 22:30, the heating resistance of the reactor was switched off because the heat production was self-sustaining. The electric field stabilizes and increases the speed of the reaction. The electric field can be used to set the materials resulting from the transmutation. As an example, starting from U, a high electric field allows to obtain a large Ba quantity and a low electric field allows to obtain a large Pb quantity. After about 40 minutes, the reactor walls broke off, with leakage of hot steam probably issued from the cooling system. Therefore the hydrogen was discharged and the process interrupted.

During this short period of activity, the heat production was quite impressive: on the cooling system, a ΔT=40.0 was measured with a flow of 650 kg/h corresponding to a power larger than 30 kW. The day after, the processed sample was brought analyzed with a Germanium chamber. For comparison, the γ-ray spectrum of a similar amount of bare uranyl acetate in a similar geometry has been analyzed. The radioactivity of the processed sample was overall 5% of the untreated one. This was infact due to the difference of weight and geometry of the two samples. The emission lines identified by the computer analysis were indeed the same with the same relative intensity. So no actual variation of the γ-ray emission by the identified nuclides was discovered. However among the faintest lines from the processed sample there are some new ones: in particular a line at 511 keV revealing positron-electron annihilation.

### Experiment 4

The purpose of the experiment here reported is to highline and demonstrate a reduction in radioactivity of a sample after a treatment. The reduction is repeatable, and it is related to a process not fully understood at this time. The sample is a hermetic container, FIGS. 11 and 12, with a radioactive material inside.

A resistance is used as a heater. The pressure inside the reactor is approximately 12 bar in the reactor and 7 bar in the container by means of two respective pressure control systems. The starting temperature measured outside the reactor is approximately 140° C. The driver comprises approximately 36 grams of approximately 70% of Nickel (Ni), 20% of Iron (Fe) and 3% of Cobalt (Co) with a particle size less than 5 micrometers and 7% of Copper (Cu) with a particle size less than 10 micrometers. The driver is arranged outside and around the container. The waste comprises approximately 1.3 grams of (UO₂(CH₃COO)₂ (CAS n^{o} 6159-44-0) with a particle size less than 5 micrometers. The balance in the center of FIG. 10 is used to weight the waste and the driver. A “hydrogen tablet”, i.e. a small core of sintered palladium hydride previously subjected to hydrogen adsorption is arranged inside the container. The temperature increase inside the airtight container provokes a release of hydrogen.

The reactor, FIG. 13, in which the process takes place is not investigable from the outside during the process. Measuring the radiation during the treatment has not been made mainly because of the little photon radioactivity of the material placed inside and also because of the shielding interposed (corresponding to one of the two walls of the reactor. Chemical and physical analyzes of the material used in the reactor during the treatment has not been made.

The goal is to highlight the effect through the evaluation of the ratio between the emission rate of the sample treated and the emission rate of the untreated one. This ratio of the radio-emissions is compared to the ratio between the weights of the sample.

The repeatability of the effect described below is validated by the repeated results. The procedure has been repeated 5 times before the present one. The reduction in activity, as described below, has been clearly observed all times.

Container
1.1. Copper hermetic cylindrical container (50 mm length, 14 mm Φ, 1÷2 mm thickness as shown on FIGS. 11 and 12). An electrical resistance, used as a heater, is disposed inside the container.
Activator, or reactor, of the process
   Metal box in pressure with an entrance to insert the container
   Electronic device to activate and control the process
   Water cooling circuit of the reactor
Reaction components (reactor content)
   Solid additive (to be mixed with the protected material that has to be treated): approximately 1.3 grams of Nickel (Ni)
   Radioactive material: CAS n^{o} 6159-44-0
Analytical balance shown on center of FIG. 10
Mettler-Toledo G603-S
Radiation measurements shown on left of FIG. 10
Single Channel Analyzer—Ludlum 2221 (Electrometer)
   GM probe Ludlum 44-9
   NaI probe (5.1×5.1 cm) Ludlum 44-10
Portable Spectrometer—Camberra Inspector 1000
   LaBr3—IPROL-1—Intelligent LaBr3 probe (30 keV to 3 MeV with 1.5 in×1.5 in, 38.1×38.1 mm) used in addiction of the 5.4, i.e. “HPGe Gamma Spectrometer—Canberra HPGe with Eagle Plus MCA in a low bkg lead shield”.
Lead shield for portable detector 5 cm thickness
HPGe Gamma Spectrometer—Canberra HPGe with Eagle Plus MCA in a low bkg lead shield shown on FIG. 10.

As presented in the introduction, the purpose of this test is to estimate the reduction of radioactivity of a sample treated with the process. The same sample, under identical conditions of measurement, shows a reduction of radioactivity. The investigation is focused on photon radio-emission radiation. The mass of the solid and confined volume of the container is constant. For this reason the mass conservation is defined on the weight of the entire hermetical container. The weight is used to estimate the mass conservation of the container, between before and after the treatment. The type of radioactivity observed is the photonic one, measured with integral (NaI) and spectrometric (HPGe) radiation detectors. In both detectors the relative position between the source (sample) and the detector before and after is comparable within the errors. The geometrical distribution of the source inside the reactor cannot be the cause of the effect described, even in the worst of the cases. The counts per minutes (CPM) rate value are measured with the integral detector (NaI). The ratio calculated on these integral values is used to demonstrate the reduction of gamma activity. The using of the spectrometric detector makes the result more complete and allows to make observations on the process.

The tests are temporally divided into three parts: before, during and after the treatment. Below are shown the measures and procedures performed for each of these parts.

Before the Treatment
1. The radio-emitting material is weighed.
2. The solid additive, here approximately 1.3 grams of Nickel (Ni) is weighed before the compound preparation according to the radioactive material.
3. The container is loaded with the compound, then the container is hermetically closed and settled.
4. The container prepared is weighed. This measurement is repeated 10 times in order to evaluate the statistical variability.
5. The gamma emission rate is measured with the NaI probe (SCA in CPM mode) in low background (bkg) shielding to emphasize the gamma signal from the sample (SNR). This measurement is repeated 10 times in order to evaluate the statistical variability. The relative position between the sample and the probe is recorded for the “after” treatment measurements.
6. The gamma radiation emission is analyzed with the HPGe spectrometer. The live time is set to 21600 s, a value such as to obtain a statistically reasonable value of counts under the major peaks. The spectrum obtained, see FIG. 14, is used for comparison only and not for the absolute measurement of the activity of the sample.

During the Treatment
1. The container is placed inside the reactor 1 activating the process, see FIG. 13. The time needed is empirically based on the experience. With the quantity, the geometry and other parameters used, it is possible to estimate 3 h as a reasonable time to obtain the result reached.

After the Treatment
1. The container containing the treated materials is weighed. This measurement is repeated 10 times as in point 1.4.
2. The gamma emission rate is measured with the NaI probe (SCA in CPM mode) in low bkg shielding to emphasize the gamma signal from the sample (SNR). This measurement is repeated 10 times as in point 1.5. The relative position between the sample and the probe is the same as the “before” treatment measurements.
3. The gamma radiation emission in analyzed with the HPGe spectrometer, see FIG. 14. The live time is set to 21.6 ks as in point 1.6.

The mass of radioactive material provided is 1 g (§1.1). The prepared container with that material weighs:
Before the treatment (§1.5): 40,666±20 mg
After the treatment (§3.2): 40,604±20 mg

The radioactivity rate is expressed as CPM. The prepared reactor (with the compound inside) weighs:
Before the treatment (§1.4): 8,860±150 CPM
After the treatment (§3.1): 1,130±100 CPM

The integral of the spectrum counts (16÷2048 keV) is:
Before the treatment: 3,925,442 Counts
After the treatment: 301,114 Counts

The difference in weight of the sample between after and before is:
D_{W}=−62±40 mg
Percentage difference: −0.15%

The difference in radioactivity rate emission between after and before is:
D_{R}=−7730±250 CPM
Percentage difference: −87.25%

The spectrum can be used for quality analysis (i.e. which energy is involved). The main energy and the related isotopes are:
Th-234 (63.29 keV, 92.5 keV, 112.81 keV)
Pa-234M (766.36 keV, 1001 keV)
U-235 (143.76 keV, 163.35 keV, 185.71 keV, 205.31 keV)
Pa-234 (131.28 keV)

It shows the reduction of activity confined inside the hermetical container. The measures must be interpreted and considered inside the cumulative errors of the method presented:
The container structure does not allow to the contained material to leave the volume. The little difference in mass D_{W} is reported. The ratio between the weights and the CsPM shows that this difference is not the cause of the reduction. In fact (0.062/l)g in the worst of the cases can bring a reduction of 10%, not enough to explain a loss of more than 90% of gamma emitting nucleus inside the reactor.
The distribution of the source inside the reactor due the process can change the efficiency of the detectors. For this reason when the sample is placed in the measuring location after the treatment it is estimated if, on the other side in respect of the one measured in the before procedure, there is more signal due the different approaching to the detector of the source inside the reactor. This evaluation shows that the difference is in any case less than 20%. The gamma reduction shown can be interpreted on the spectrum presented with the substitution of radioactive material with stable material having undetectable emitting. The confined volume in which the radioactive material is contained leaves us the only interpretation of the results as a change, due to the process, in the radioactive proprieties of the nucleus involved.

The output energy of the system, according to the conducted experiments and preliminary theoretical assessments, depend significantly on the conduct of the trial and the amount of products (radionuclides and driver) present in the reactor.

### 1 Energy Yield

More in detail, the higher the temperature of the process (ie the greater the intensity of treatment), the higher the COP is revealed. The COP (coefficient of performance) measures the ratio between input and output energy of a system or a process. For example, COP=30 means that a certain process provides energy measure thirty times higher than that necessary to activate it and support it.

Similarly the duration of the process increases the energy surplus, predominantly—but not exclusively—in function of the fact that the maximum amount of energy is supplied to the system during start-up, while the heat production increases rapidly, for then remain substantially constant throughout the process.

The amount of material present in the apparatus determines—at least theoretically—the possible duration of the process. But the amount of material does not intervene—in practice—in the definition of energy efficiency of the system. This statement, however, shall be interpreted with restraint, as the percentage of the mass involved in the processes of transmutation (into elements non-activated in the process) or mass loss (production of surplus energy) is so small as to ensure that, in essence, the duration of the process (and the consequent production of surplus energy) depend on the volume of the apparatus (saturated with hydrogen) and the pressure at which the environment is maintained during the treatment process.

As an example we present some experimental cases, with different conditions of treatment and duration.

### 1.a Low Intensity Process

The test was carried out under the conditions summarized here:
1.a.1 testing time: 9,240 seconds (about two hours thirty-four minutes)
1.a.2 quantity of material used (total): 7.654 g (±10%) of which:
   1.a.2.1 radionuclides: 0.819 g (±10%)
   1.a.2.2 metallic drivers: 6.835 g (±10%)
1.a.3 energy supplied to the system during the entire duration of the test: 0.63 kWhₑ
1.a.4 energy generated during the entire duration of the test: 4.3396 kWhₜ
1.a.5 COP: 7.0907711.

For more details, see Experiment 2.

### 1.b Medium-Low Intensity Process

The test was carried out under the conditions summarized here:
1.b.1 testing time: 22,414 seconds (about six hours and fourteen minutes);
1.b.2 quantity of material used (total): 12.581 g (±10%) of which:
   1.b.2.1 radionuclides: 1.309 g (±10%)
   1.b.2.2 metallic drivers: 11.272 g (±10%);
1.b.3 energy supplied to the system during the entire duration of the test: 1,269 kWhₑ
1. b.4 energy generated during the entire duration of the test: 16,893 kWhₜ
1.b.5 COP: 13.3120567.
For more details, see Experiment 4.

### 1. c Medium Intensity Process

The test was carried out under the conditions summarized here:
1.c.1 testing time: 27,805 seconds (about seven hours and forty-three minutes);
1.c.2 quantity of material used (total): 17.806 g (±10%) of which:
   1.c.2.1 radionuclides: 1.804 g (±10%)
   1.c.2.2 metallic drivers: 16.002 g (±10%);
1.c.3 energy supplied to the system during the entire duration of the test: 2.491 kWhₑ
1. c.4 energy generated during the entire duration of the test: 62.397 kWhₜ
1.c.5 COP: 25.0489763.

### 1. d Theoretical Evaluations

Theoretical calculations of energy productivity, carried out by Professor Sergio Focardi (Nuclear Physics, University of Bologna), offered a COP value equal to 463 (value significantly higher than that recorded during experiments, which are preliminary).

### 1.e Attempts to Conclusions

Wanting groped by plotting the energy productivity of the mass of the products used, will only be possible to establish a minimum.

None of the experiments carried out has led to depletion potential of the treated materials (and even hydrogen): the theory is that the term can be calculated in months. In laboratory conditions, the time duration of the experiment is limited by the quantity of hydrogen. From 0.5 to 4 liters of hydrogen at about 10 bars, the time limit si approximately between 20 days and 4 months.

In short, according to the experimental values by a kilogram of processed products will not be able to get less than 3,365 kWh net. By reporting the minimum experimental theoretical calculations, the net value of production of energy from a kilogram of processed products will amount to 62,186 kWh.

### 2 Possible Mechanisms of Transmutation

2.a ⁶⁰₂₇Co

The decay of ⁶⁰Co (synthetic radioactive isotope—whose half-life was 5.27 years—obtained from ⁵⁹₂₇ Co by neutron activation) occurs naturally towards ⁶⁰₂₈ Ni. The nuclear equation of the total reaction can be expressed as follows:

$${ }_{27}^{59} Co + n {\to }_{27}^{60} Co {\to }_{28}^{60} Ni + e ‡ \begin{matrix}γ ( 1.17 MeV ) \\ γ ( 1.33 MeV )\end{matrix}$$

That is (only for the terminal decay):

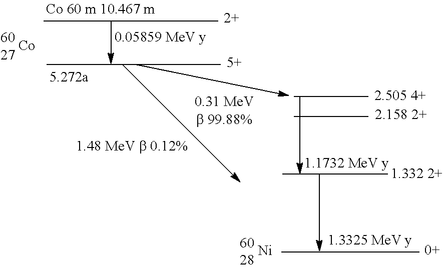

The transmutation occurs with β decay until ⁶⁰₂₈Ni* (excited nickel-60), then the nickel-60 switches to its lowest energy state by emitting a gamma ray. That is:

₂₇⁶⁰Co→₂₈⁶⁰Ni*+e⁻+νₑ

where ν̅ₑ is the electron antineutrino,

₂₈⁶⁰Ni→₂₈⁶⁰Ni+γ

This second notation better illustrates the role of electrostatic polarization.

In the experimental phase, the sample was analyzed by SEM EDAX, obtaining the spectrum shown in FIG. 5. The spectrum clearly shows the presence—almost exhaustive—of nickel, highlighted by three peaks (marked with the symbol Ni). The position in which a peak of cobalt would appear, had he been present, is indicated by the symbol Co. The same reading of the spectrum, however, suggests the formation of two different stable isotopes of nickel:

⁶⁰Co+p⁺→⁶¹Ni

⁶⁰Co+2p⁺→⁶²Ni

Which is to highlight the role of ultrasound. An explanation could be that the polarization and the “neutron cloud” facilitates appearance of these two unusual isotopes.
2.b ¹³⁷₅₅Cs

The decay of ¹³⁷Co (radioactive isotope of cesium—whose half-life was 30.17 years—which is formed mainly as a byproduct of the nuclear fission of uranium, especially in nuclear fission reactors) occurs naturally towards ¹³⁷₅₆Ba. The nuclear equation (only for the terminal decay) can be expressed as follows:

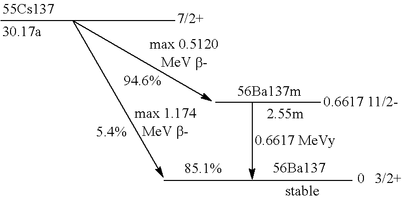

The transmutation occurs with β decay until ¹³⁷₅₆Ba* (excited barium-137), then the barium-137 passes to the state of minimum energy by gamma emissions. Any additional deduction and evaluation is set up as quite similar to those—already described—expressed for the ⁶⁰₂₇Co.

2. c ²³⁵₉₂U(+²³⁸₉₂U)

The product based on uranium used (CAS n^{o} 6159-44-0) sees that the present both the ²³⁵U ²³⁸U, which have very different mode of natural decay.

By way of example, let us examine briefly the decay chain found in the case in which the metal is subjected to treatment ²³⁵U. The results are those of the transmutation of uranium in the stable isotopes of barium and krypton. ²³⁵U acquires a proton from the treatment (in the same environment an electron is freed, as a result) becoming ephemeral ²³⁶U (²³⁶Np).

²³⁵U+p⁺→²³⁶U[²³⁶Np](→e⁻)

²³⁶U decays almost instantly, forming ¹⁴¹Ba and ⁹²Kr—both unstable—and freeing environment of a positron treatment.

²³⁶U→¹⁴¹Ba+⁹²Kr(→e⁺)

Electron and positron annihilate with the emission of energy (absorbed by fluid retention of the cooling system).

e⁻+e⁺→2γ

The unstable ¹⁴¹Ba and ⁹²Kr decay instantly to their stable forms (¹³⁸Ba and ⁸⁹Kr) with the issue, in both the cases of three neutrons.

¹⁴¹Ba→¹³⁸Ba+3n

⁹²Kr→⁸⁹Kr+3n

The six neutrons (lifetime≦1.100 s) are finally thermalized in the fluid containment.

1-31. (canceled)

32. An exothermic transmutation method for at least partially deactivating radioactive material, the method comprising the steps of:
Arranging a dusty compound comprising at least a transition metal in a chamber of a reactor outside a closed container;
Arranging the radioactive material in said chamber, the radioactive material being and staying encapsulated in said closed container;
Providing hydrogen in contact with the dusty compound and with the radioactive material at a pressure higher than the ambient pressure;
Generating an electric field in the chamber, the electric field being applied to the dusty compound and the radioactive material;
Energizing the dusty compound by heating, then generating a transmutation of said at least one transition metal into another transition metal and proton emission towards the radioactive material, said radioactive material being at least partially deactivated,
Removing thermal energy from the reactor.

33. Method according to claim 32, wherein the radioactive material is a nuclear waste.

34. Method according to claim 32, comprising a step of removing air from the chamber and a step of heating the chamber at an initial temperature.

35. Method according to claim 32, wherein the dusty compound comprises Ni and Fe, 50% to 95% Ni and 5% to 50% Fe in weight, Ni atoms being transmuted into Cu.

36. Method according to claim 32, wherein the dusty compound comprises 1% to 10% Cu in mass.

37. Method according to claim 36, wherein the Cu of the dusty compound has at least 99% of particles of an average size between 10 and 100 μm.

38. Method according to claim 32, wherein the Ni of the dusty compound has at least 99% of particles of an average size not greater than 10 μm, and the Fe of the dusty compound has at least 99% of particles of an average size not greater than 10 μm.

39. Method according to claim 32, wherein the dusty compound comprises 25% to 40% graphite in mass.

40. Method according to claim 32, wherein the pressure in said chamber during electric field and ultrasonic wave generation is greater than 5×10⁵ Pa, said chamber containing at least 99% H₂.

41. Method according to claim 32, wherein hydrogen is provided before heating and stay in the chamber during the subsequent steps.

42. Method according to claim 32, wherein the initial temperature is between 80 and 200° C.

43. Method according to claim 32, wherein the dusty compound comprises Cr, the same dusty compound composition is used for various radioactive materials and the same dusty compound is used for a plurality of radioactive material deactivations.

44. Method according to claim 32, wherein the electric field is essentially static and is between 20 and 30000 volts/m.

45. Method according to claim 32, wherein the radioactive material is a powder having at least 99% of particles of an average size not greater than 10 μm.

46. Method according to claim 32, wherein the hydrogen is deprived of voluntary addition of deuterium and tritium.

47. Method according to claim 32, wherein the ultrasonic waves have a frequency between 250 and 600 kHz and the ultrasonic waves are generated by a generator having a power between 400 and 2000 W.

48. Method according to claim 32, wherein the electric field and the ultrasonic waves are generated after heating the chamber at said initial temperature, heating being maintained during a first part of an electric field and ultrasonic waves generation period, heating being stopped at the end of said first part, removing thermal energy starting after said first part.

49. Method according to claim 32, wherein an electric field and ultrasonic waves generation period has duration between 1 and 6 hours.

50. An exothermic transmutation method for at least partially deactivating radioactive material, the method comprising the steps of:
Arranging a dusty compound comprising at least a transition metal in a chamber of a reactor;
Arranging the radioactive material in said chamber, the radioactive material being close to or mixed with the dusty compound;
Providing hydrogen in contact with the dusty compound and with the radioactive material at a pressure higher than the ambient pressure;
Generating an electric field in the chamber, the electric field being applied to the dusty compound and the radioactive material;
Energizing the dusty compound by ultrasonic waves, then generating a transmutation of said at least one transition metal into another transition metal and proton emission towards the radioactive material, said radioactive material being at least partially deactivated,
Removing thermal energy from the reactor.

51. Method according to claim 50, comprising heating the dusty compound and the radioactive material.
